(19) United States
(12) Patent Application Publication
(10) Pub. No.: US 2026/0121544 A1
(43) Pub. Date: Apr. 30, 2026

(54) POWER SUPPLY DEVICE

(71) Applicant: Chicony Power Technology Co., Ltd., New Taipei City (TW)

(72) Inventors: Tso-Jen Peng, New Taipei City (TW); Mao-Song Pan, New Taipei City (TW)

(73) Assignee: Chicony Power Technology Co., Ltd., New Taipei City (TW)

(21) Appl. No.: 19/003,263

(22) Filed: Dec. 27, 2024

(30) Foreign Application Priority Data
Jul. 19, 2024 (TW) 113127230

(51) Int. Cl. H02M 3/335; H02M 3/00

(52) U.S. Cl. CPC H02M 3/33569; H02M 3/01

(57) ABSTRACT

A power supply device includes a transformer, a primary circuit, a secondary circuit, and a mode control unit. The transformer is coupled between the primary circuit and the secondary circuit. The primary circuit includes two rectifying switches. The secondary circuit includes a mode switching switch. The mode control unit is coupled between one of the two rectifying switches and the mode switching switch to control the mode switching switch to be turned on or off based on a switching state of the coupled rectifying switch. When the power supply device operates in a first operating mode, the mode switching switch is synchronized with the lower arm switch, and the power supply device outputs a first voltage. When the power supply device operates in a second operating mode, the mode switching switch is turned on, and the power supply device outputs a second voltage higher than the first voltage.

### CROSS-REFERENCE TO RELATED APPLICATION

This non-provisional application claims priority under 35 U.S. C. § 119(a) to Patent Application No. 113127230 filed in Taiwan, R.O. C. on Jul. 19, 2024, the entire contents of which are hereby incorporated by reference.

### BACKGROUND

### Technical Field

The disclosure relates to a power supply device, and in particular, to a power supply device capable of changing operating modes according to output demands.

### Related Art

Current power supply protocols (e.g., USB Power Delivery) regulate a variety of output voltages, but different power conversion circuits have different performance when dealing with these output voltages. Some power conversion circuits can flexibly output various output voltages, while others excel in conversion efficiency.

### SUMMARY

A power supply device according to an example of the disclosure includes a transformer, a primary circuit, a secondary circuit, and a mode control unit. The transformer includes a primary coil and a secondary coil. The primary circuit includes a resonant capacitor and a first rectifying circuit. The first rectifying circuit includes two rectifying switches. The two rectifying switches are an upper arm switch and a lower arm switch connected in series. One end of the primary coil is coupled between the upper arm switch and the lower arm switch. The other end of the primary coil and an end of the lower arm switch away from the upper arm switch are respectively coupled to two ends of the resonant capacitor. The secondary circuit includes a second rectifying circuit, a voltage output terminal, an output capacitor, and a mode switching switch. The second rectifying circuit is coupled to the secondary coil. The output capacitor is coupled in parallel between the second rectifying circuit and the voltage output terminal. The mode switching switch is coupled between the output capacitor and the second rectifying circuit. The mode control unit is coupled between one of the two rectifying switches and the mode switching switch to control the mode switching switch to be turned on or off based on a switching state of the coupled rectifying switch. When the power supply device operates in a first operating mode, the mode switching switch is synchronized with the lower arm switch, and the voltage output terminal outputs a first voltage. When the power supply device operates in a second operating mode, the mode switching switch is turned on, and the voltage output terminal outputs a second voltage higher than the first voltage.

In an example, when a feedback voltage of the voltage output terminal is less than a reference voltage, the power supply device operates in the first operating mode, and when the feedback voltage is not less than the reference voltage, the power supply device operates in the second operating mode.

In an example, the rectifying switch to which the mode control unit is coupled is the upper arm switch. The mode control unit includes a processing unit, a NOT gate, and an OR gate. The processing unit generates a mode signal based on a feedback voltage. The feedback voltage reflects a voltage state of the voltage output terminal. The NOT gate is coupled to a control terminal of the upper arm switch to output a switching signal reflecting the switching state of the upper arm switch. The OR gate includes a first input terminal, a second input terminal, and a signal output terminal. The first input terminal is coupled to the NOT gate to receive the switching signal. The second input terminal is coupled to the processing unit to receive the mode signal. The signal output terminal is coupled to the mode switching switch to output a transition signal to the mode switching switch such that the mode switching switch is controlled by the transition signal to be turned on or off.

In an example, the processing unit is a comparator, including a first comparison terminal, a second comparison terminal, and a result output terminal. The first comparison terminal receives the feedback voltage. The second comparison terminal receives a reference voltage. The result output terminal generates the mode signal. When the feedback voltage is less than the reference voltage, the mode signal is at a low level such that the power supply device operates in the first operating mode. When the feedback voltage is not less than the reference voltage, the mode signal is at a high level such that the power supply device operates in the second operating mode.

In an example, the rectifying switch to which the mode control unit is coupled is the lower arm switch. The mode control unit includes a processing unit and an OR gate. The processing unit generates a mode signal based on a feedback voltage. The feedback voltage reflects a voltage state of the voltage output terminal. The OR gate includes a first input terminal, a second input terminal, and a signal output terminal. The first input terminal is coupled to a control terminal of the lower arm switch to receive a switching signal reflecting the switching state of the lower arm switch. The second input terminal is coupled to the processing unit to receive the mode signal. The signal output terminal is coupled to the mode switching switch to output a transition signal to the mode switching switch such that the mode switching switch is controlled by the transition signal to be turned on or off.

In an example, the processing unit is a comparator, including a first comparison terminal, a second comparison terminal, and a result output terminal. The first comparison terminal receives the feedback voltage. The second comparison terminal receives a reference voltage. The result output terminal generates the mode signal. When the feedback voltage is less than the reference voltage, the mode signal is at a low level such that the power supply device operates in the first operating mode. When the feedback voltage is not less than the reference voltage, the mode signal is at a high level such that the power supply device operates in the second operating mode.

In an example, when the power supply device operates in the first operating mode, an asymmetrical half-bridge conversion circuit is formed. When the power supply device operates in the second operating mode, an LLC resonant conversion circuit is formed. The reference voltage is set as an intersection of an output voltage range of the asymmetrical half-bridge conversion circuit and a resonance point output voltage range of the LLC resonant conversion circuit.

In an example, the reference voltage is 48 volts.

In an example, the power supply device further includes a regulation circuit, coupled to the first rectifying circuit to control a switching time of the upper arm switch and the lower arm switch such that the upper arm switch and the lower arm switch are alternately turned on. When the power supply device operates in the first operating mode, the upper arm switch has a first on period, and the lower arm switch has a second on period. There is a first dead time when the first on period is switched to the second on period. There is a second dead time when the second on period is switched to the first on period. The first dead time is less than the second dead time.

In an example, when the power supply device operates in the second operating mode, the upper arm switch has a third on period, and the lower arm switch has a fourth on period. There is a third dead time when the third on period is switched to the fourth on period. There is a fourth dead time when the fourth on period is switched to the third on period. The third dead time is substantially the same as the fourth dead time.

The power supply device according to the examples provided by the disclosure has the advantages of the two power conversion circuits, and can switch to an appropriate operating mode according to output demands. In some examples, mode switching can be realized by simple logic circuits, which is advantageous for implementation in products.

### BRIEF DESCRIPTION OF THE DRAWINGS

FIG. 1 is a schematic circuit diagram of a power supply device according to an example of the disclosure;

FIG. 2 is a schematic operating mode switching sequence diagram according to an example of the disclosure;

FIG. 3 is a schematic diagram when an upper arm switch is turned on in an asymmetrical half-bridge mode according to an example of the disclosure;

FIG. 4 is a schematic diagram when a lower arm switch is turned on in an asymmetrical half-bridge mode according to an example of the disclosure;

FIG. 5 is a schematic diagram when the upper arm switch is turned on in an LLC resonant mode according to an example of the disclosure;

FIG. 6 is a schematic diagram when the lower arm switch is turned on in an LLC resonant mode according to an example of the disclosure;

FIG. 7 is a schematic circuit diagram of a mode control unit according to an example of the disclosure;

FIG. 8 is a schematic circuit diagram of a mode control unit according to another example of the disclosure;

FIG. 9 is a graph showing the relationship between a turns ratio and an optimal output voltage of a transformer in multiple power conversion circuits;

FIG. 10 is a graph showing the change in current of the primary coil in the asymmetrical half-bridge mode; and

FIG. 11 is a graph showing the change in current of the primary coil in the LLC resonant mode.

### DETAILED DESCRIPTION

As used herein, “coupled” means that two or more components “directly” make physical or electrical contact with each other or “indirectly” make physical or electrical contact with each other, or that two or more components interact with each other.

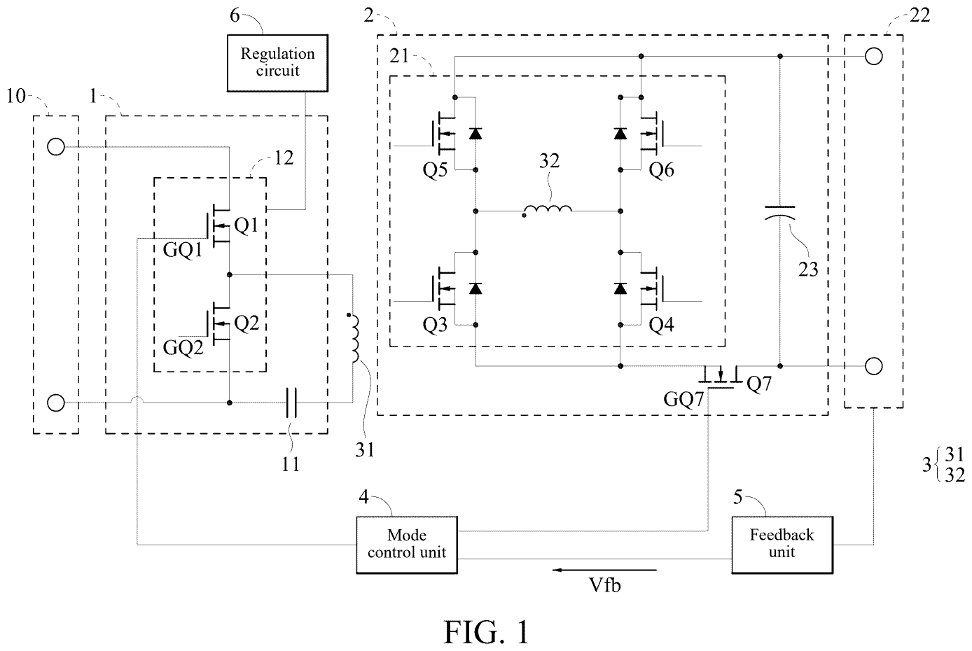

Reference is made to FIG. 1, which is a schematic circuit diagram of a power supply device according to an example of the disclosure. The power supply device includes a primary circuit 1, a secondary circuit 2, a transformer 3, and a mode control unit 4. The transformer 3 is coupled between the primary circuit 1 and the secondary circuit 2. The transformer 3 includes a primary coil 31 and a secondary coil 32. The primary coil 31 is coupled to the primary circuit 1 to couple energy of the primary circuit 1 to the secondary coil 32. The secondary coil 32 is coupled to the secondary circuit 2 to transfer the coupled energy to the secondary circuit 2.

The primary circuit 1 is coupled to a voltage input terminal 10 to receive a power input. The primary circuit 1 includes a resonant capacitor 11 and a first rectifying circuit 12. The first rectifying circuit 12 includes two rectifying switches. The two rectifying switches are an upper arm switch Q1 and a lower arm switch Q2 connected in series. One end of the primary coil 31 is coupled between the upper arm switch Q1 and the lower arm switch Q2. The other end of the primary coil 31 and an end of the lower arm switch Q2 away from the upper arm switch Q1 are respectively coupled to two ends of the resonant capacitor 11.

The secondary circuit 2 includes a second rectifying circuit 21, a voltage output terminal 22, an output capacitor 23, and a mode switching switch Q7. The second rectifying circuit 21 is coupled to the secondary coil 32. The output capacitor 23 is coupled in parallel between the second rectifying circuit 21 and the voltage output terminal 22. The mode switching switch Q7 is coupled between the output capacitor 23 and the second rectifying circuit 21. As shown in FIG. 1, the second rectifying circuit 21 is a full-bridge rectifying circuit, including switches Q3-Q6. Anodes of body diodes of the switches Q3 and Q4 are coupled to the mode switching switch Q7. A cathode of a body diode of the switch Q3 is coupled to an anode of a body diode of the switch Q5 and coupled to one end of the secondary coil 32. A cathode of the body diode of the switch Q4 is coupled to an anode of a body diode of the switch Q6 and coupled to the other end of the secondary coil 32. Cathodes of the body diodes of the switches Q5 and Q6 are coupled to the output capacitor 23. Although the second rectifying circuit 21 of FIG. 1 takes the full-bridge rectifying circuit as an example, the disclosure is not limited thereto. In some examples, the second rectifying circuit 21 may be implemented as a half-bridge rectifying circuit.

The mode control unit 4 is coupled between one of the two rectifying switches (i.e., the upper arm switch Q1 or the lower arm switch Q2) of the first rectifying circuit 12 and the mode switching switch Q7 to control the mode switching switch Q7 to be turned on or off based on a switching state of the coupled rectifying switch, such that the power supply device operates in the first operating mode or the second operating mode. FIG. 1 is an example where the mode control unit 4 is coupled to the upper arm switch Q1. Therefore, the mode control unit 4 controls the mode switching switch Q7 to be turned on or off according to the switching state of the upper arm switch Q1.

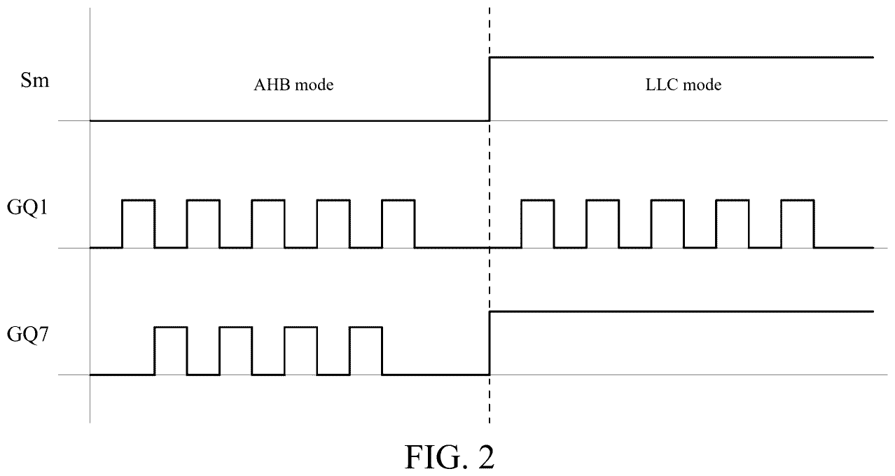

Reference is made to FIG. 1 and FIG. 2 together. FIG. 2 is a schematic operating mode switching sequence diagram according to an example of the disclosure. Two level states of a mode signal Sm represent two operating modes. In some examples, the first operating mode is an asymmetrical half-bridge (AHB) mode, and the second operating mode is an LLC resonant mode. In an example, the mode signal Sm being at a low level represents the asymmetrical half-bridge (AHB) mode, and the mode signal Sm being at a high level represents the LLC resonant mode. FIG. 2 shows states of a control terminal GQ1 of the upper arm switch Q1 and a control terminal GQ7 of the mode switching switch Q7 in two operating modes. The high level means that the corresponding switch is turned on, and the low level means that the corresponding switch is turned off.

When the power supply device operates in the asymmetrical half-bridge mode, the mode switching switch Q7 is asynchronous with the upper arm switch Q1 (that is, the mode switching switch Q7 is synchronized with the lower arm switch Q2) to form an asymmetrical half-bridge conversion circuit, such that the voltage output terminal 22 outputs a first voltage. When the power supply device operates in the LLC resonant mode, the mode switching switch Q7 is turned on to form an LLC resonant conversion circuit, such that the voltage output terminal 22 outputs a second voltage. In the asymmetrical half-bridge mode, the upper arm switch Q1 and the lower arm switch Q2 are alternately turned on with an asymmetrical duty cycle. During an on period of the upper arm switch Q1, the primary coil 31 and the resonant capacitor 11 are charged to accumulate energy. During an on period of the lower arm switch Q2, the energy of the primary coil 31 and the resonant capacitor 11 is released to the secondary circuit 2. Therefore, although the asymmetrical half-bridge mode has the advantages of zero voltage switching and variable voltage output, the asymmetrical half-bridge mode is not suitable for providing large current. When a high power output is needed, the power supply device is switched to the LLC resonant mode, so that the second voltage higher than the first voltage can be provided. Therefore, when the higher second voltage (higher power) output is needed, the power supply device operates in the second operating mode (e.g., the LLC resonant mode), and when the lower first voltage (lower power) output is needed, the power supply device operates in the first operating mode (e.g., the asymmetrical half-bridge mode).

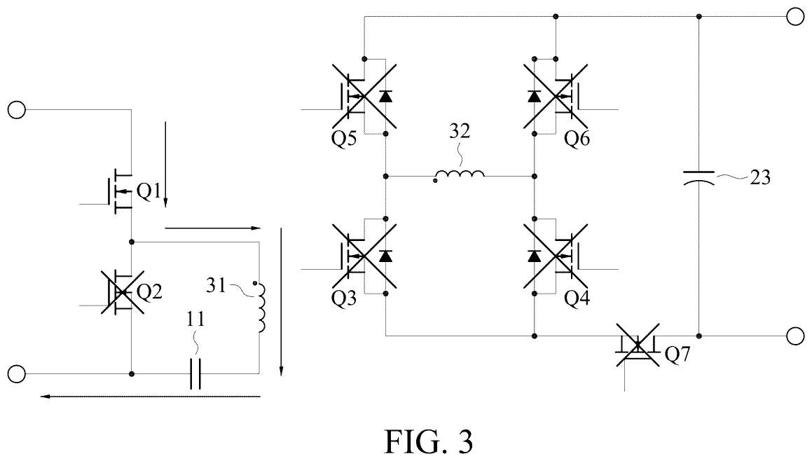

Reference is made to FIG. 3, which is a schematic diagram when the upper arm switch Q1 is turned on in the asymmetrical half-bridge mode according to an example of the disclosure. In the primary circuit 1, the upper arm switch Q1 is turned on, and the lower arm switch Q2 is turned off. Accordingly, in the secondary circuit 2, the mode switching switch Q7 is turned off, such that the loop of the secondary circuit 2 forms an open circuit and cannot operate normally, which allows the energy to be accumulated in the primary coil 31 and the resonant capacitor 11.

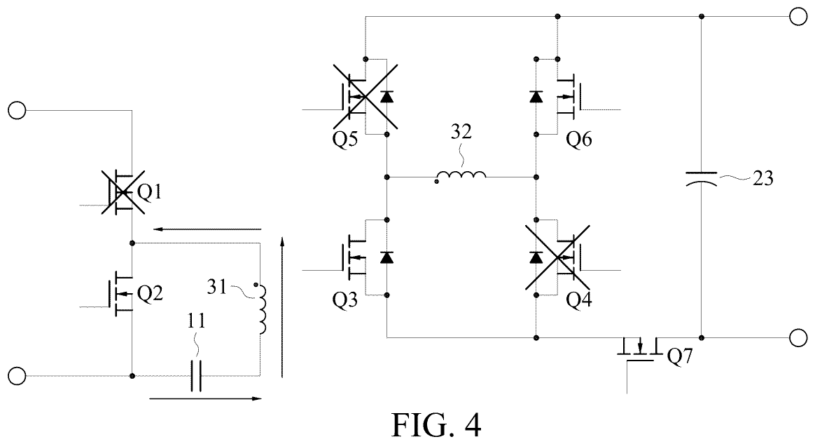

Reference is made to FIG. 4, which is a schematic diagram when the lower arm switch Q2 is turned on in the asymmetrical half-bridge mode according to an example of the disclosure. In the primary circuit 1, the lower arm switch Q2 is turned on, and the upper arm switch Q1 is turned off, so that the primary coil 31, the lower arm switch Q2, and the resonant capacitor 11 form a loop that releases energy. Accordingly, in the secondary circuit 2, the mode switching switch Q7 is turned on, such that the loop of the secondary circuit 2 operates normally, which allows the energy accumulated by the resonant capacitor 11 to be transferred to the secondary circuit 2 so as to output the first voltage. Besides, the switches Q3 and Q6 are turned on to form a current path, and the switches Q4 and Q5 are turned off to prevent a short circuit and a reverse current.

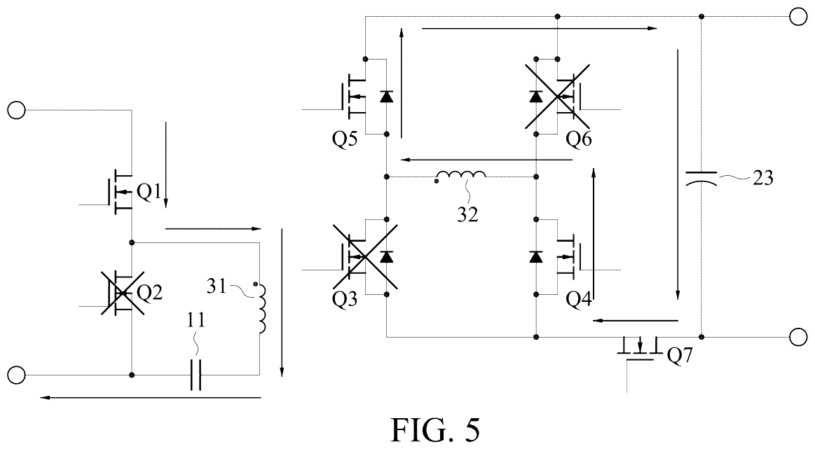

Reference is made to FIG. 5, which is a schematic diagram when the upper arm switch Q1 is turned on in the LLC resonant mode according to an example of the disclosure, which shows a positive half-cycle action. In the primary circuit 1, the upper arm switch Q1 is turned on, and the lower arm switch Q2 is turned off. Accordingly, in the secondary circuit 2, the mode switching switch Q7 is turned on, such that the loop of the secondary circuit 2 operates normally. Besides, the switches Q4 and Q5 are turned on to form a current path, and the switches Q3 and Q6 are turned off to prevent a short circuit and a reverse current.

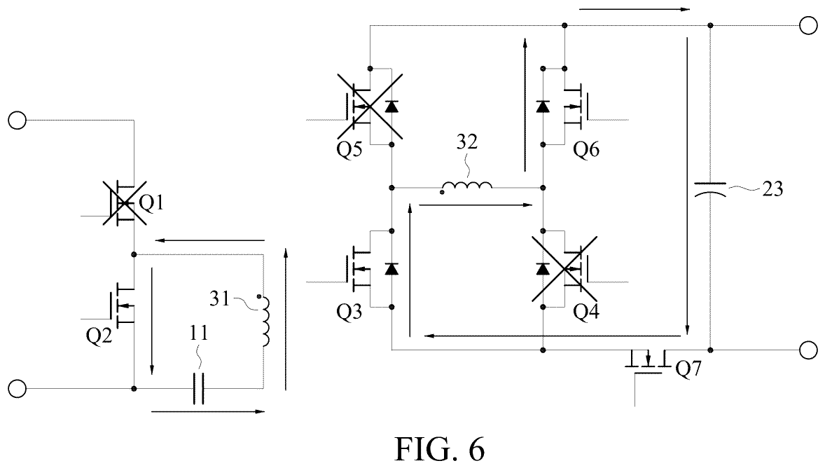

Reference is made to FIG. 6, which is a schematic diagram when the lower arm switch Q2 is turned on in the LLC resonant mode according to an example of the disclosure, which shows a negative half-cycle action. In the primary circuit 1, the lower arm switch Q2 is turned on, and the upper arm switch Q1 is turned off. Accordingly, in the secondary circuit 2, the mode switching switch Q7 is turned on, such that the loop of the secondary circuit 2 operates normally. Besides, the switches Q3 and Q6 are turned on to form a current path, and the switches Q4 and Q5 are turned off to prevent a short circuit and a reverse current.

As shown in FIG. 1, the power supply device further includes a feedback unit 5, coupled between the voltage output terminal 22 and the mode control unit 4. The feedback unit 5 generates a feedback voltage Vfb according to an output voltage of the voltage output terminal 22 and transmits the feedback voltage Vfb to the mode control unit 4. The feedback voltage Vfb may reflect a voltage state of the voltage output terminal 22. The mode control unit 4 determines whether to switch the operating mode according to the feedback voltage Vfb. When the feedback voltage Vfb is less than a reference voltage (not shown), the power supply device operates in the asymmetrical half-bridge mode. When the feedback voltage Vfb is not less than the reference voltage (not shown), the power supply device operates in the LLC resonant mode.

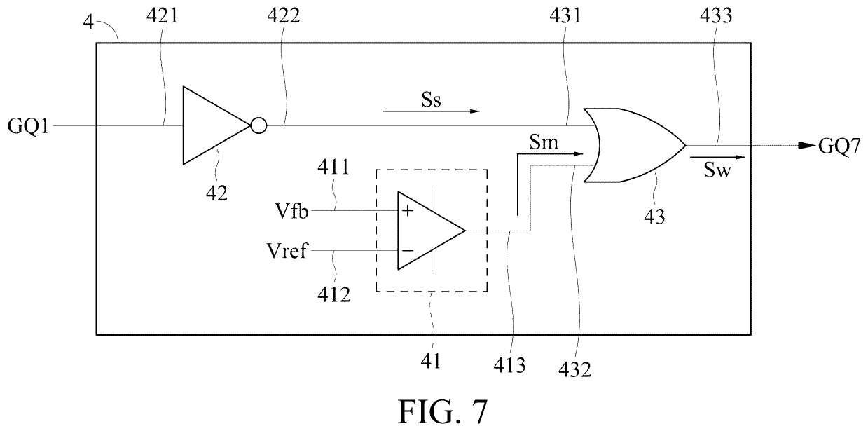

Reference is made to FIG. 7, which is a schematic circuit diagram of the mode control unit 4 according to an example of the disclosure. The mode control unit 4 is coupled to the control terminal GQ1 of the upper arm switch Q1 to obtain the switching state of the upper arm switch Q1. The mode control unit 4 is further coupled to the feedback unit 5 to receive the feedback voltage Vfb. The mode control unit 4 is coupled to the control terminal GQ7 of the mode switching switch Q7 to control the switching state of the mode switching switch Q7. The mode control unit 4 includes a processing unit 41, a NOT gate 42, and an OR gate 43.

The NOT gate 42 includes an input terminal 421 and an output terminal 422. The input terminal 421 is coupled to the control terminal GQ1 of the upper arm switch Q1. The output terminal 422 outputs a switching signal Ss reflecting the switching state of the upper arm switch Q1. When the control terminal GQ1 of the upper arm switch Q1 is at a low level (the upper arm switch Q1 is turned off), the switching signal Ss is at a high level. When the control terminal GQ1 of the upper arm switch Q1 is at a high level (the upper arm switch Q1 is turned on), the switching signal Ss is at a low level. In other words, the switching signal Ss is inverse to the voltage level of the control terminal GQ1 of the upper arm switch Q1.

The processing unit 41 generates the mode signal Sm based on the feedback voltage Vfb. In an example, the processing unit 41 is a comparator, including a first comparison terminal 411, a second comparison terminal 412, and a result output terminal 413. The first comparison terminal 411 is coupled to the feedback unit 5 to receive the feedback voltage Vfb. The second comparison terminal 412 receives a reference voltage Vref. The result output terminal 413 generates the mode signal Sm according to a comparison result between the feedback voltage Vfb and the reference voltage Vref.

Reference is made to FIG. 2 and FIG. 7 together. when the feedback voltage Vfb is less than the reference voltage Vref (there is no higher power demand), the mode signal Sm is at a low level (as shown in FIG. 2) to control the mode switching switch Q7 correspondingly, such that the power supply device operates in the asymmetrical half-bridge mode. When the feedback voltage Vfb is not less than the reference voltage Vref (there is a higher power demand), the mode signal Sm is at a high level (as shown in FIG. 2) to control the mode switching switch Q7 correspondingly, such that the power supply device operates in the LLC resonant mode.

The OR gate 43 includes a first input terminal 431, a second input terminal 432, and a signal output terminal 433. The first input terminal 431 is coupled to the output terminal 422 of the NOT gate 42 to receive the switching signal Ss. The second input terminal 432 is coupled to the processing unit 41 to receive the mode signal Sm. The OR gate 43 performs an OR operation on the switching signal Ss and the mode signal Sm to generate a transition signal Sw. The signal output terminal 433 is coupled to the control terminal GQ7 of the mode switching switch Q7 to output the transition signal Sw to the mode switching switch Q7, such that the mode switching switch Q7 is controlled by the transition signal Sw to be turned on or off. Reference is made to FIG. 1 and FIG. 2. When the mode signal Sm is at a high level, the transition signal Sw (the control terminal GQ7 of the mode switching switch Q7) is at a high level through the operation of the OR gate 43. When the mode signal Sm is at a low level, the transition signal Sw is the same as the switching signal Ss through the operation of the OR gate 43. Since the control terminal GQ1 of the upper arm switch Q1 is inverse to the switching signal Ss, the voltage level of the transition signal Sw (the control terminal GQ7 of the mode switching switch Q7) is opposite to the voltage level of the control terminal GQ1 of the upper arm switch Q1.

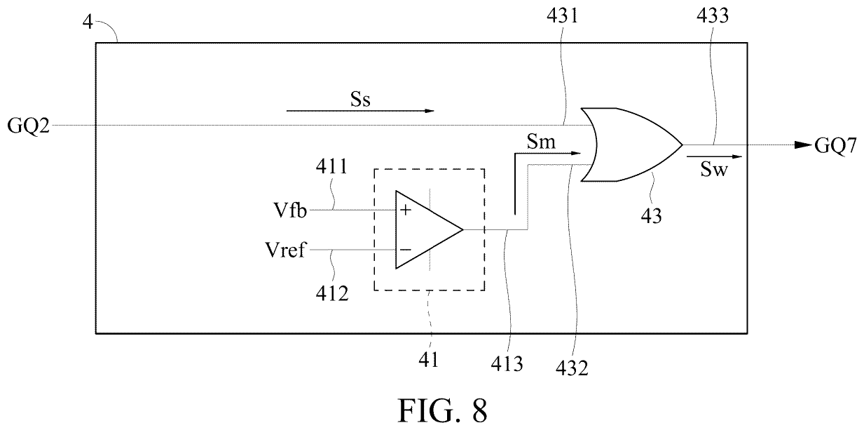

Reference is made to FIG. 8, which is a schematic circuit diagram of a mode control unit 4 according to another example of the disclosure. The difference from FIG. 7 is that the mode control unit 4 does not have the NOT gate 42 and the first input terminal 431 of the OR gate 43 is coupled to a control terminal GQ2 of the lower arm switch Q2. Generally, the control terminal GQ1 of the upper arm switch Q1 and the control terminal GQ2 of the lower arm switch Q2 are inverse to each other. Therefore, removing the NOT gate 42 and coupling to the control terminal GQ2 of the lower arm switch Q2 can still make the switching signal Ss inverse to the voltage level of the control terminal GQ1 of the upper arm switch Q1.

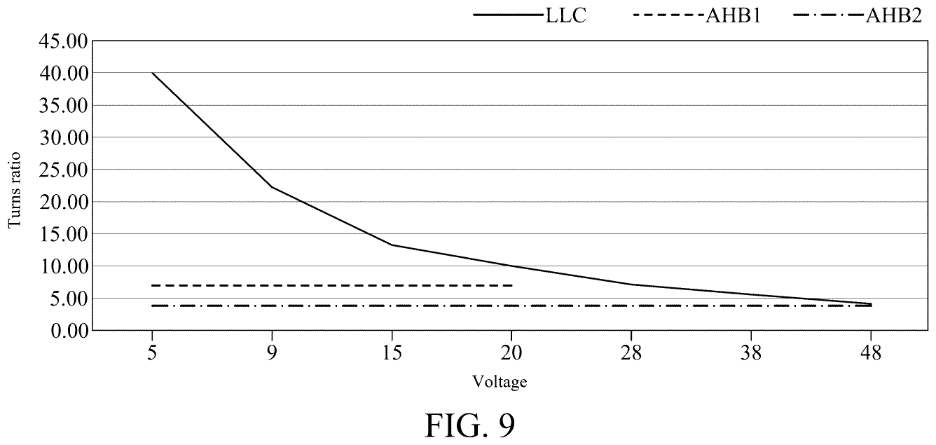

Reference is made to FIG. 9, which is a graph showing the relationship between a turns ratio and an optimal output voltage of the transformer 3 in multiple power conversion circuits. Line LLC represents an LLC resonant conversion circuit having an output voltage range of 5-48 volts. Line AHB1 represents an asymmetrical half-bridge conversion circuit having an output voltage range of 5-20 volts. Line AHB2 represents an asymmetrical half-bridge conversion circuit having an output voltage range of 5-48 volts. As can be seen, in order to combine the LLC resonant conversion circuit and the asymmetrical half-bridge conversion circuit in one circuit, at the intersection of Line LLC and Line AHB2, i.e., when the turns ratio of the transformer 3 is 4.17, the optimal output voltage of the two circuits falls at 48 volts. Therefore, in an example, 48 volts is used as the switching point of the two operating modes, that is, the reference voltage Vref is 48 volts. However, the disclosure is not limited to this voltage value, and the reference voltage Vref is set at an intersection of an output voltage range of the asymmetrical half-bridge conversion circuit and a resonance point output voltage range of the LLC resonant conversion circuit.

Referring to FIG. 1, the power supply device further includes a regulation circuit 6, coupled to the first rectifying circuit 12 to control a switching time of the upper arm switch Q1 and the lower arm switch Q2 such that the upper arm switch Q1 and the lower arm switch Q2 are alternately turned on. However, in order to prevent the upper arm switch Q1 and the lower arm switch Q2 to be turned on at the same time, there is a dead time (first dead time) when the on period of the upper arm switch Q1 (the first on period) is switched to the on period of the lower arm switch Q2 (second on period). There is a dead time (second dead time) when the on period of the lower arm switch Q2 (second on period) is switched to the on period of the upper arm switch Q1 (first on period).

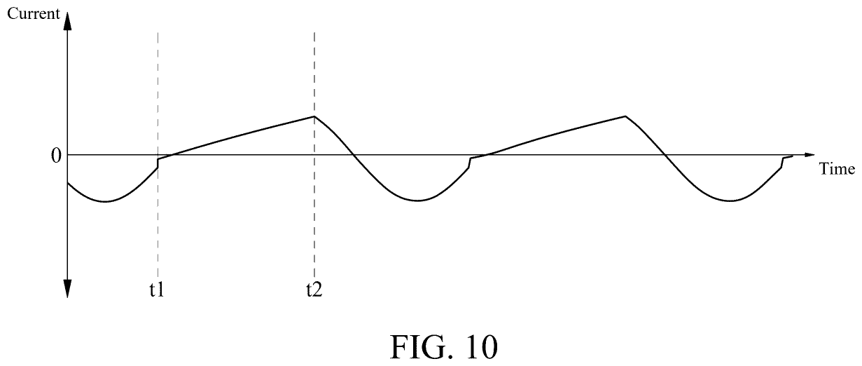

Reference is made to FIG. 10, which is a graph showing the change in current of the primary coil 31 in the asymmetrical half-bridge mode. Between time point t1 and time point t2, the upper arm switch Q1 is turned on such that the current gradually increases. At time point t2, the current is cut off at a high point. At this time, in order to turn on the lower arm switch Q2 to achieve zero voltage switching, the corresponding period of the first dead time needs to be enough to eliminate the voltage difference between the two ends of the lower arm switch Q2. In this case, a larger current can quickly eliminate the voltage difference between the two ends of the lower arm switch Q2, so the first dead time should be short. On the contrary, at time point t1, the current is close to 0. In order to turn on the upper arm switch Q1 to achieve zero voltage switching, the corresponding period of the second dead time needs to be enough to eliminate the voltage difference between the two ends of the upper arm switch Q1, so the second dead time should be long. Therefore, the first dead time should be less than the second dead time.

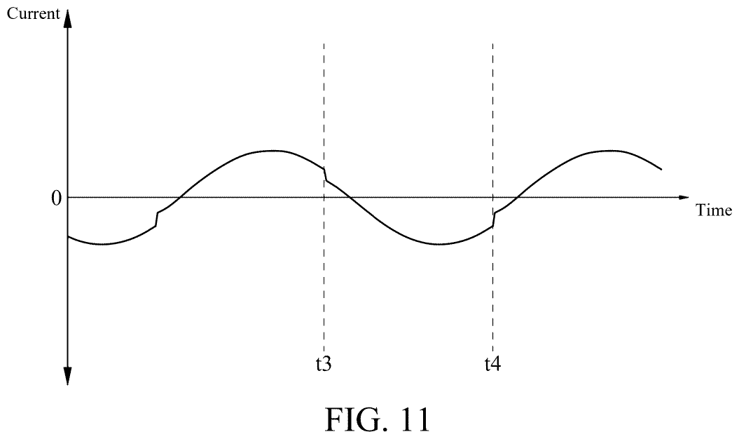

Reference is made to FIG. 11, which is a graph showing the change in current of the primary coil 31 in the LLC resonant mode. Time point t3 and time point t4 are two dead time points respectively. As can be seen, the current changes symmetrically, so the two dead times (a third dead time and a fourth dead time) need to be substantially the same. There is a third dead time when the on period of the upper arm switch Q1 (third on period) is switched to the on period of the lower arm switch Q2 (fourth on period). There is a fourth dead time when the on period of the lower arm switch Q2 (fourth on period) is switched to the on period of the upper arm switch Q1 (third on period).

In some examples, the regulation circuit 6 is further coupled to control terminals (not shown) of the switches Q3-Q6 to control the switches Q3-Q6 to perform the aforementioned turn-on or turn-off.

In some examples, the regulation circuit 6 is a digital controller having functions of digital signal processing, operation and control, which is, for example, but not limited to, a microcontroller, a digital signal processor (DSP), a field-programmable gate array (FPGA) or an application-specific integrated circuit (ASIC).

In some examples, the upper arm switch Q1, the lower arm switch Q2, the switches Q3-Q6 or/and the mode switching switch Q7 are implemented as N-type metal-oxide-semiconductor FETs (NMOSFETs), but the disclosure is not limited thereto.

The power supply device according to the examples provided by the disclosure has the advantages of the two power conversion circuits, and can switch to an appropriate operating mode according to output demands. In some examples, mode switching can be realized by simple logic circuits, which is advantageous for implementation in products.

What is claimed is:

1. A power supply device, comprising:
a transformer, comprising a primary coil and a secondary coil;
a primary circuit, comprising:
a resonant capacitor; and
a first rectifying circuit, comprising two rectifying switches, the two rectifying switches being an upper arm switch and a lower arm switch connected in series, one end of the primary coil being coupled between the upper arm switch and the lower arm switch, and the other end of the primary coil and an end of the lower arm switch away from the upper arm switch being respectively coupled to two ends of the resonant capacitor;
a secondary circuit, comprising:
a second rectifying circuit, coupled to the secondary coil;
a voltage output terminal;
an output capacitor, coupled in parallel between the second rectifying circuit and the voltage output terminal; and
a mode switching switch, coupled between the output capacitor and the second rectifying circuit; and
a mode control unit, coupled between one of the two rectifying switches and the mode switching switch to control the mode switching switch to be turned on or off based on a switching state of the coupled rectifying switch;
wherein when the power supply device operates in a first operating mode, the mode switching switch is synchronized with the lower arm switch, and the voltage output terminal outputs a first voltage; and when the power supply device operates in a second operating mode, the mode switching switch is turned on, and the voltage output terminal outputs a second voltage higher than the first voltage.

2. The power supply device according to claim 1, wherein when a feedback voltage of the voltage output terminal is less than a reference voltage, the power supply device operates in the first operating mode, and when the feedback voltage is not less than the reference voltage, the power supply device operates in the second operating mode.

3. The power supply device according to claim 2, wherein when the power supply device operates in the first operating mode, an asymmetrical half-bridge conversion circuit is formed, and when the power supply device operates in the second operating mode, an LLC resonant conversion circuit is formed, wherein the reference voltage is set as an intersection of an output voltage range of the asymmetrical half-bridge conversion circuit and a resonance point output voltage range of the LLC resonant conversion circuit.

4. The power supply device according to claim 2, wherein the reference voltage is 48 volts.

5. The power supply device according to claim 1, wherein the rectifying switch to which the mode control unit is coupled is the upper arm switch, and the mode control unit comprises:
a processing unit, generating a mode signal based on a feedback voltage, the feedback voltage reflecting a voltage state of the voltage output terminal;
a NOT gate, coupled to a control terminal of the upper arm switch to output a switching signal reflecting the switching state of the upper arm switch; and
an OR gate, comprising a first input terminal, a second input terminal and a signal output terminal, the first input terminal being coupled to the NOT gate to receive the switching signal, the second input terminal being coupled to the processing unit to receive the mode signal, and the signal output terminal being coupled to the mode switching switch to output a transition signal to the mode switching switch such that the mode switching switch is controlled by the transition signal to be turned on or off.

6. The power supply device according to claim 5, wherein the processing unit is a comparator, comprising a first comparison terminal, a second comparison terminal and a result output terminal, the first comparison terminal receiving the feedback voltage, the second comparison terminal receiving a reference voltage, and the result output terminal generating the mode signal, wherein when the feedback voltage is less than the reference voltage, the mode signal is at a low level such that the power supply device operates in the first operating mode, and when the feedback voltage is not less than the reference voltage, the mode signal is at a high level such that the power supply device operates in the second operating mode.

7. The power supply device according to claim 6, wherein when the power supply device operates in the first operating mode, an asymmetrical half-bridge conversion circuit is formed, and when the power supply device operates in the second operating mode, an LLC resonant conversion circuit is formed, wherein the reference voltage is set as an intersection of an output voltage range of the asymmetrical half-bridge conversion circuit and a resonance point output voltage range of the LLC resonant conversion circuit.

8. The power supply device according to claim 6, wherein the reference voltage is 48 volts.

9. The power supply device according to claim 1, wherein the rectifying switch to which the mode control unit is coupled is the lower arm switch, and the mode control unit comprises:
a processing unit, generating a mode signal based on a feedback voltage, the feedback voltage reflecting a voltage state of the voltage output terminal; and
an OR gate, comprising a first input terminal, a second input terminal and a signal output terminal, the first input terminal being coupled to a control terminal of the lower arm switch to receive a switching signal reflecting the switching state of the lower arm switch, the second input terminal being coupled to the processing unit to receive the mode signal, and the signal output terminal being coupled to the mode switching switch to output a transition signal to the mode switching switch such that the mode switching switch is controlled by the transition signal to be turned on or off.

10. The power supply device according to claim 9, wherein the processing unit is a comparator, comprising a first comparison terminal, a second comparison terminal and a result output terminal, the first comparison terminal receiving the feedback voltage, the second comparison terminal receiving a reference voltage, and the result output terminal generating the mode signal, wherein when the feedback voltage is less than the reference voltage, the mode signal is at a low level such that the power supply device operates in the first operating mode, and when the feedback voltage is not less than the reference voltage, the mode signal is at a high level such that the power supply device operates in the second operating mode.

11. The power supply device according to claim 10, wherein when the power supply device operates in the first operating mode, an asymmetrical half-bridge conversion circuit is formed, and when the power supply device operates in the second operating mode, an LLC resonant conversion circuit is formed, wherein the reference voltage is set as an intersection of an output voltage range of the asymmetrical half-bridge conversion circuit and a resonance point output voltage range of the LLC resonant conversion circuit.

12. The power supply device according to claim 10, wherein the reference voltage is 48 volts.

13. The power supply device according to claim 1, further comprising a regulation circuit, coupled to the first rectifying circuit to control a switching time of the upper arm switch and the lower arm switch such that the upper arm switch and the lower arm switch are alternately turned on, wherein when the power supply device operates in the first operating mode, the upper arm switch has a first on period, and the lower arm switch has a second on period; there is a first dead time when the first on period is switched to the second on period; and there is a second dead time when the second on period is switched to the first on period, wherein the first dead time is less than the second dead time.

14. The power supply device according to claim 13, wherein when the power supply device operates in the second operating mode, the upper arm switch has a third on period, and the lower arm switch has a fourth on period; there is a third dead time when the third on period is switched to the fourth on period; and there is a fourth dead time when the fourth on period is switched to the third on period, wherein the third dead time is substantially the same as the fourth dead time.
